(19) United States
(12) Patent Application Publication
(10) Pub. No.: US 2021/0362489 A1
(43) Pub. Date: Nov. 25, 2021

(54) THERMAL ZONE SELECTION WITH A SEQUENCER AND DECODERS

(71) Applicant: Hewlett-Packard Development Company, L.P., Spring, TX (US)

(72) Inventors: Daryl E. Anderson, Corvallis, OR (US); Eric Martin, Corvallis, OR (US); James Michael Gardner, Corvallis, OR (US)

(73) Assignee: Hewlett-Packard Development Company, L.P., Spring, TX (US)

(21) Appl. No.: 17/046,881

(22) PCT Filed: Jun. 11, 2018
(86) PCT No.: PCT/US2018/036907

§ 371 Date: Oct. 12, 2020

(51) Int. Cl. B41J 2/045

(52) U.S. Cl. CPC B41J 2/04528; B41J 2/04541; B41J 2/04563; B41J 2/04543

(57) ABSTRACT

Examples of a fluidic die for thermal zone selection with a sequencer and decoders are described herein. In some examples, the fluidic die includes multiple thermal zones. Each thermal zone includes a temperature sensor, a fluidic actuator and a decoder. The fluidic die also includes shared thermal control circuitry to process an output of the temperature sensor in a selected thermal zone. The fluidic die further includes a sequencer to output a sequence state to select one thermal zone at a time for processing by the shared thermal control circuitry. The decoder of the selected thermal zone decodes the sequence state.

### BACKGROUND

Fluid ejection systems may be used to emit a fluid. For example, printing devices provide a user with a physical representation of a document by printing a digital representation of a document onto a print medium. The printing devices may include a number of fluidic dies used to eject ink or other printable material onto the print medium to form an image. In some examples, a fluidic die may deposit fluid droplets onto the print medium using a number of fluidic actuators (e.g., resistive elements) within the fluidic die. In other examples, a fluidic actuator may move a fluid on the fluidic die.

### BRIEF DESCRIPTION OF THE DRAWINGS

FIG. 1 is a simplified block diagram of a fluid ejection system incorporating a fluidic die for thermal zone selection with a sequencer and decoders according to an example of the principles described herein;

FIG. 2 is a block diagram illustrating an example of a fluidic die;

FIG. 3 is a block diagram illustrating an example of a fluidic die for thermal zone selection with a sequencer and decoders;

FIG. 4 is a flow diagram illustrating a method for thermal zone selection with a sequencer and decoders; and

FIG. 5 is a flow diagram illustrating another method for thermal zone selection with a sequencer and decoders.

Throughout the drawings, identical reference numbers designate similar, but not necessarily identical, elements. The figures are not necessarily to scale, and the size of some parts may be exaggerated to more clearly illustrate the example shown. Moreover the drawings provide examples and/or implementations consistent with the description; however, the description is not limited to the examples and/or implementations provided in the drawings.

### DETAILED DESCRIPTION

The disclosure describes systems, methods and apparatus to provide for continuous sequential selection of thermal zones of a fluidic die to be processed by shared thermal control circuitry. The fluidic die includes multiple thermal zones of at least one fluidic actuator. The fluidic die also includes shared thermal control circuitry for processing the thermal zones. The sequential selection of thermal zones is done by a global sequencer with related decoders in each thermal zone, which allows for selecting one zone at a time for thermal processing. The sequencer is advanced by a command from the thermal control resource once processing of the current zone is complete.

In some examples, the fluidic die may include at least one resistive element that generates heat in a thermal zone. The fluidic die may also include other circuits that produce heat in their operational modes. As the fluidic die elements produce heat, it may be desirable to measure and control the temperature of each thermal zone.

Examples described herein relate to selecting a thermal zone for processing by shared thermal control circuitry. In some examples, the temperature of the multiple thermal zones of a fluidic die may be controlled using components and sequences of operations described herein. In such examples, control of thermal zones of a fluidic die may be referred to as switch zone warming. Switch zone warming corresponds to independent management and control of distinct thermal regions on an example fluidic die.

Each thermal zone of the fluidic die may have a temperature sensor. Shared thermal control circuitry in the fluidic die may be coupled to the thermal zones. The shared thermal control circuitry may determine if the temperature of a given thermal zone is less than a target temperature (also referred to as a setpoint temperature or setpoint). In some examples, the target temperature can be applied globally to the entire fluidic die. In other examples, the target temperature may be unique for each thermal zone.

If a thermal zone's temperature is less than the target temperature, then the thermal zone is instructed by the shared thermal control circuitry to allow warming to occur. Subsequent analysis of the temperature by the shared thermal control circuitry will determine whether to actuate heating elements. For example, control circuitry may electrically actuate heating elements in the thermal zone based on the thermal zone temperature. The control circuits may adjust pulses to heating elements based on the thermal zone temperature.

Another benefit of the switch zone warming sensing is that for a fluidic die that includes fluidic actuators, knowing the temperature of different zones can be used to modulate the energy used to actuate the fluidic actuators. For example, if the fluidic die (or fluid) is warmer, a reduced actuation energy may be used.

In some approaches, warming is accomplished by turning a heater on or off. However, in other approaches (e.g., switch zone warming), a precursor pulse (PCP) may occur before the main fire pulse in a thermal zone. The PCP may be adjusted to compensate for the temperature variation without the need to add heat to or remove heat from the fluidic die. For example, in this approach, thermal zones that are warmer may have their PCP trimmed, thereby maintaining the correct drop weight. Alternatively, thermal zones that are cooler may have their PCP lengthened.

Temperature sensors may be spread across a large distance on the fluidic die. For example, temperature sensors may be spread across the fluidic die in physically dispersed thermal zones. Because the temperature of various regions on the fluidic die may vary, a fluidic die controller may determine the temperature gradients through measuring of the multiple temperature sensors on the fluidic die.

A fluidic die may include a shared thermal control circuitry (also referred to as a common thermal control resource) to process the multiple thermal zones. A method to select the thermal zones to be processed is discussed herein. For a fluidic die with multiple thermal zones, addressing of thermal zones, while allowing for arbitrary selection of the thermal zones, is unnecessarily expensive and complicated (e.g., due to the area used on the fluidic die and the complexity of the logic). As described herein, selection of the thermal zones for processing by the shared thermal control circuitry may be accomplished according to a pre-defined sequence.

In the following description, for purposes of explanation, numerous specific details are set forth in order to provide a thorough understanding of the present systems and methods. As may be appreciated, the present apparatus, systems, and methods may be practiced without these specific details. Reference in the specification to “an example” or similar language means that a particular feature, structure, or characteristic described in connection with that example is included as described, but may not be included in other examples.

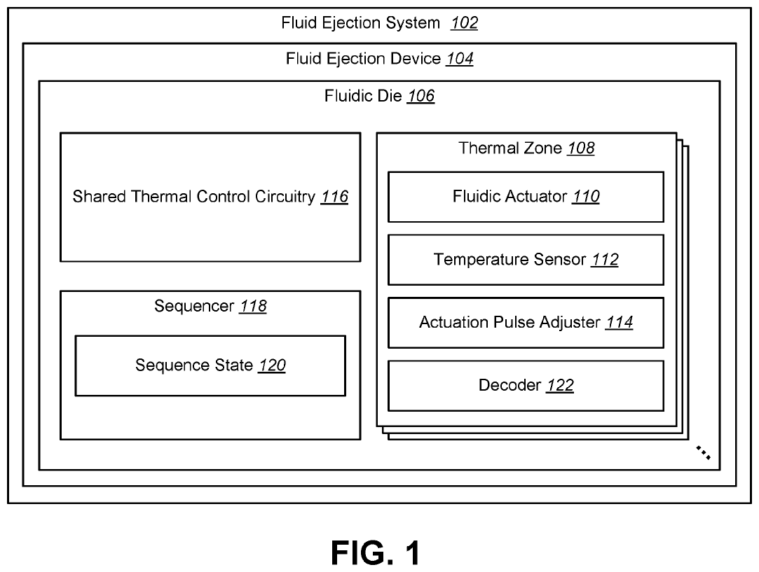

FIG. 1 is a simplified block diagram of a fluid ejection system 102 incorporating a fluidic die 106 for thermal zone selection with a sequencer 118 and decoders 122 according to an example of the principles described herein. To achieve its desired functionality, the fluid ejection system 102 may include various hardware components. For example, among these hardware components may be a number of processors, a number of data storage devices, a number of peripheral device adapters, and a number of network adapters (not shown). These hardware components may be interconnected through the use of a number of busses and/or network connections.

In some examples, the fluid ejection system 102 may be a two-dimensional (2D) printer (e.g., thermal inkjet printer, piezoelectric inkjet printer, etc.) In other examples, the fluid ejection system 102 may be a three-dimensional (3D) printer. In other examples, the fluid ejection system 102 may correspond to pharmaceutical dispensation devices, lab-on-a-chip devices, fluidic diagnostic circuits, and/or other such devices in which small volumes (e.g., microliters, picoliters, etc.) of fluid may be conveyed, analyzed, and/or dispensed.

The fluid ejection system 102 also includes a number of fluid ejection devices 104. Although one fluid ejection device 104 is depicted in the example of FIG. 1, any number of fluid ejection devices 104 may exist within the fluid ejection system 102. The fluid ejection devices 104 may be fixed or scanning fluid ejection devices. The fluid ejection devices 104 may be coupled to the processor of the fluid ejection system 102 via a bus. The fluid ejection devices 104 may receive print data in the form of a print job. For example, the print data may be consumed by the fluid ejection devices 104 and used to produce a physical print representing the print job.

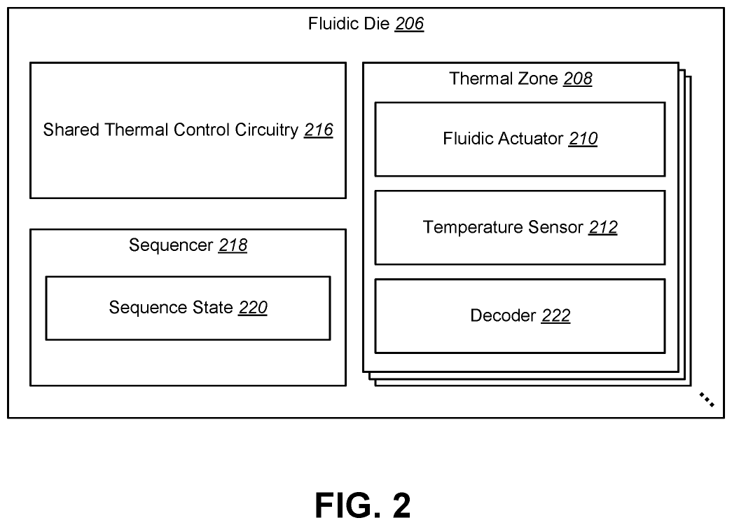

Each fluid ejection device 104 includes a number of fluidic dies 106. Although one fluidic die 106 is depicted in the example of FIG. 1, any number of fluidic dies 106 may exist within the fluid ejection device 104. A fluidic die 106 may include multiple thermals zones 108. An example of a fluidic die is described in connection with FIG. 2.

Each thermal zone 108 may include a number of fluidic actuators 110 (also referred to as a primitive). The thermal zones may include a single fluidic actuator 110 or multiple fluidic actuators 110.

In some examples, the fluidic actuator 110 may be an ejecting actuator. An ejecting actuator may correspond to a fluidic actuator 110 disposed in an ejection chamber, where the ejection chamber may be fluidically coupled to a nozzle. Accordingly, by electrically actuating an ejection actuator, a drop of fluid may be ejected via the nozzle fluidically coupled to the ejection chamber. For instance, a fluid (e.g., ink) may flow through the fluidic die 106 to a fluidic actuator 110. In some examples, the fluidic actuator 110 may deposit the fluid on a print medium. In other examples, the fluidic actuator 110 may eject the fluid without a print medium.

In some examples, the fluidic actuator 110 may use heat to cause the fluid to exit the fluidic actuator 110 (through a nozzle, for instance). For instance, the fluidic actuator 110 may generally refer to a resistor (e.g., thermal resistor or a piezoelectric resistor) disposed in an ejection chamber.

In other examples, the fluidic actuator 110 may be a non-ejecting actuator. For example, the fluidic actuator 110 may be a micro-pump that moves fluid on the fluidic die 106. In such examples, a fluidic actuator 110 in the form of a micro-pump may be disposed in a microfluidic channel. Accordingly, actuation of the fluidic actuator 110 in such examples may cause displacement of fluid in the microfluidic channel.

As used herein, a “fluid ejection device” and a “fluidic die” mean that part of a fluid ejection system 102 that dispenses fluid from one or more openings. A fluid ejection device includes a number of fluidic dies. “Fluid ejection device” and “fluidic die” are not limited to printing with ink and other printing fluids but may also include dispensing of other fluids and/or for uses other than printing.

A thermal zone 108 may include at least one temperature sensor 112. The temperature sensor 112 may measure the temperature of the thermal zone 108. For example, it may be beneficial to know the average temperature of the fluidic actuators 110 in a given thermal zone 108. In some examples, the fluidic actuators 110 in a given thermal zone 108 may receive the same pulse, and an average temperature of the fluidic actuators 110 (e.g., nozzles) in the thermal zone 108 may be determined. In some approaches, a thermal zone 108 may include multiple temperature sensors 112 from which an average temperature for the thermal zone 108 may be determined. In other approaches, the thermal zone 108 may include a single temperature sensor 112 at a specific point in the thermal zone 108, which may be used to represent the average temperature of the thermal zone 108.

A thermal zone 108 may also include an actuation pulse adjuster 114. The actuation pulse adjuster 114 may adjust an actuation pulse. As used herein, an actuation pulse may include a precursor pulse (PCP), a fire pulse or some other actuation pulse for the fluidic actuator 110. A PCP may occur before the main fire pulse in a thermal zone 108. The PCP may be adjusted by the actuation pulse adjuster 114 to compensate for the temperature variation to reduce having to adjust the temperature on the fluidic die 106 (e.g., by adding heat to or removing heat from the fluidic die 106). The actuation pulse adjuster 114 may receive an adjustment value for an adjusted actuation pulse from the shared thermal control circuitry 116.

The actuation pulse adjuster 114 may output an adjusted actuation pulse to drive heating of the thermal zone 108. In some examples, the actuation pulse adjuster 114 may adjust the PCP based on the adjustment value. In other examples, the actuation pulse adjuster 114 may adjust the main fire pulse based on the adjustment value. In yet other examples, the actuation pulse adjuster 114 may adjust the some other actuation pulse based on the adjustment value.

The fluidic die 106 may include shared thermal control circuitry 116 to process the multiple thermal zones 108. As used herein, processing a thermal zone 108 by the shared thermal control circuitry 116 may include receiving a temperature sensor output from a given thermal zone 108, determining an adjustment value for the actuation pulse based on the temperature sensor output and sending the adjustment value to the actuation pulse adjuster 114 of the given thermal zone 108. The shared thermal control circuitry 116 may be coupled to the multiple thermal zones 108.

The systems, apparatus and methods described herein provide for continually selecting thermal zones 108 in sequence so that the thermal zones 108 can be processed to control the temperature of those thermal zones 108. This thermal zone selection may be done in a fashion that ensures each thermal zone 108 is processed frequently enough to prevent thermal overshoot or undershoot.

The thermal zone selection process may be implemented by having each thermal zone 108 processed by the shared thermal control circuitry 116 in sequence. The thermal zone selection sequence may be repeated (rather than randomly selecting thermal zones 108, for instance). This means that the multiple thermal zones 108 are to be processed within the limited amount of time before a thermal zone's temperature moves further than desired.

The described systems, methods and apparatus provide for continuous sequential selection of thermal zones 108 to be processed by the shared thermal control circuitry 116. The thermal zone selection may be implemented by a sequencer 118 with related decoders 122 in each thermal zone 108, which provides for selecting one thermal zone 108 for processing by the shared thermal control circuitry 116.

The sequencer 118 may store a sequence state 120. The sequence state 120 indicates which thermal zone 108 is selected for thermal processing. In some examples, the sequencer 118 may be implemented as a counter. The sequence state 120 may be sized (e.g., number of bits) so that a unique sequence state 120 (e.g., count) is generated for each thermal zone 108. For example, the sequence state 120 may have a number of bits such that each thermal zone 108 may be uniquely identified by a state of the bits. Therefore, the sequence state 120 may be an encoded identifier of a thermal zone 108. The sequence state 120 of the sequencer 118 may (or may not) be initialized to a specific count (e.g., “0”).

Each thermal zone 108 may include a decoder 122. The decoder 122 may include a decode function (e.g., gates) that will decode a specific sequence state 120 to activate the selected thermal zone 108. For example, a given decoder 122 may be configured with a certain value of the sequence state 120. The decoder 122 may decode the sequence state 120 when the value of the sequence state 120 matches the configured sequence state value of the thermal zone 108. Otherwise, the decoder 122 may not decode the sequence state 120.

When a decoder 122 decodes the sequence state 120, then the thermal zone 108 of the decoder 122 is selected for processing by the shared thermal control circuitry 116. In other words, when a decoder 122 decodes the sequence state 120 matching the sequence state value of the thermal zone 108, then the thermal zone 108 is selected to be in an active state. When the thermal zone 108 is in the active state, the thermal zone 108 may transmit a thermal state (e.g., temperature sensor output) to the shared thermal control circuitry 116. Additionally, when in an active state, the thermal zone 108 may receive thermal control results (e.g., an adjustment value for an adjusted actuation pulse) from the shared thermal control circuitry 116.

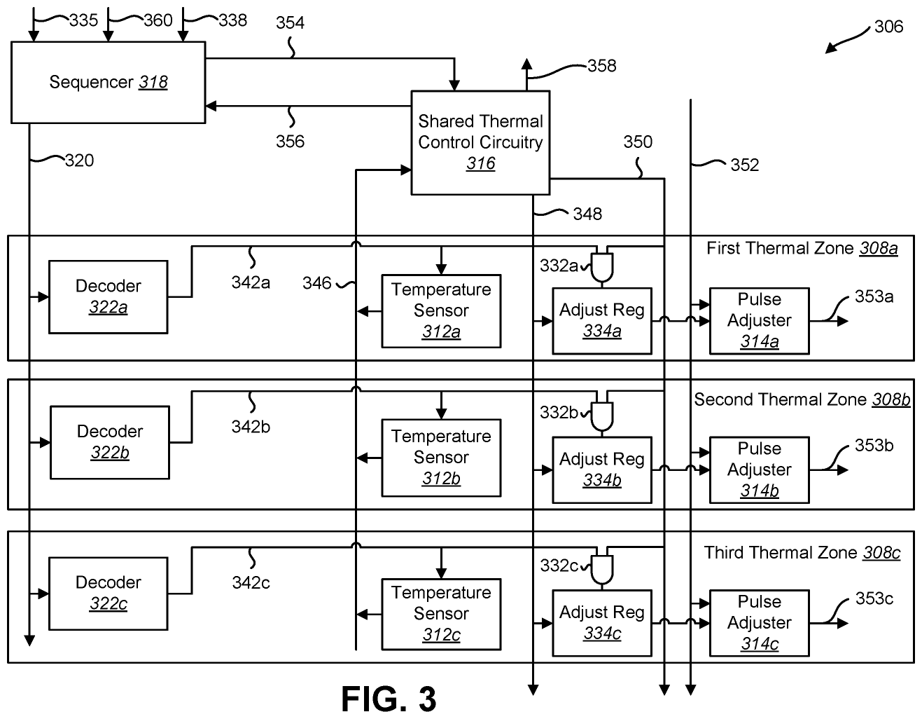

Once the thermal control processing has been completed for that thermal zone 108, the shared thermal control circuitry 116 may send a command (e.g., clock pulse) to the sequencer 118 to increment the sequence state 120 by a certain amount. For example, the sequencer 118 to increment the sequence state 120 by one. Upon incrementing the sequence state 120, the next thermal zone 108 may be selected for processing. An example, of thermal zone selection with a sequencer 118 and decoders 122 is described in FIG. 3.

In an example, when the sequence state 120 reaches the final thermal zone 108 and that thermal zone 108 has been processed, the sequence state 120 may be reset to 0 (e.g., the first zone). For example, if there are three thermal zones 108, then the sequence state 120 may be a two-bit number having four different states (e.g., “00”, “01”, “10” and “11”). In this example, the sequence state 120 of “00” may be associated with the first thermal zone 108, the sequence state 120 of “01” may be associated with the second thermal zone 108, and the sequence state 120 of “10” may be associated with the third thermal zone 108. When the sequence state 120 reaches the value of “10” for the third thermal zone 108 (i.e., the final thermal zone), the sequence state 120 may be reset to “00”, and the thermal zone selection sequence may continue.

In another example, when the sequence state 120 reaches the final thermal zone 108, the sequencer 118 may increment the sequence state 120 through the remainder of its range (causing thermal processing to occur on non-zones, which can be ignored), before recycling to 0. In the example with three thermal zones 108, when the sequence state 120 reaches the value of “10” for the third thermal zone 108 (i.e., the final thermal zone), the sequencer 118 may continue to increment the sequence state 120 to “11,” which is an unassigned sequence state 120. However, the shared thermal control circuitry 116 may ignore thermal processing in this non-zone.

In some examples, for better spatial distribution of thermal zone selection during a full cycle, the sequence state 120 of the sequencer 118 may be advanced each time by an amount other than “1”. For example, decodes for each thermal zone 108 may be configured such that spatially adjacent zones decode to adjacent sequence state values. In this case, by configuring the sequence state increment value, thermal processing can be controlled such that selected thermal zones 108 “jump around” on the fluidic die 106 for optimal spatial and temporal distribution of thermal processing. For example, if a column of 16 thermal zones 108 is decoded, top to bottom, to 0-15 sequentially, and the sequence state 120 is configured to advance by 5, then the selected thermal zones 108 might be 0, 5, 10, 15, 4, 9, 14, 3, 8, 13, 2, 7, 12, 1, 6, 11, 0, 5, 10, etc. Therefore, the sequence used for thermal zone selection may be optimized based on the thermal zone spatial distribution.

In some examples, an arbitrarily designated thermal zone 108 may be selected for processing by the shared thermal control circuitry 116. For example, a specific sequence state 120 may be issued by the sequencer 118 to cause a certain thermal zone 108 to be selected for processing.

In some examples, the sequencer 118 may be initialized once at fluidic die startup. Upon initialization, a selected sequence state 120 may be communicated by the sequencer 118. Thus, the thermal zone 108 associated with the selected sequence state 120 may be in an active state upon initialization.

The thermal zone selection described herein provides for repeating, sequential selection of all thermal zones 108 for thermal processing with minimal circuitry per zone. Furthermore, the thermal zone selection may operate autonomously (e.g., without thermal zone addressing that originates outside the fluidic die). With minimal circuitry and/or logic, the sequence state 120 can be configured for optimal spatial and temporal distribution of warming control on the fluidic die 106.

Performing thermal zone selection on the fluidic die 106 provides additional benefits. For example, locating the shared thermal control circuitry 116 on the same fluidic die 106 as the thermal zones 108 may reduce errors caused by an electrically noisy environment. The number of interconnections between the fluidic die 106 and other components outside the fluidic die 106 may also be reduced, which reduces the complexity, cost and size due to the number of pads used for interconnections. Also, the sensing bandwidth of the temperature sensors 112 may be increased. Additionally, for test modes (or printer modes), thermal zones 108 can be arbitrarily addressed.

FIG. 2 is a block diagram illustrating an example of a fluidic die 206. The fluidic die 206 may be implemented in accordance with the fluidic die 106 described in connection with FIG. 1.

The fluidic die 206 may include multiple thermal zones 208. Each thermal zone 208 may include a temperature sensor 212, a fluidic actuator 210 and a decoder 222. The fluidic die 206 may also include shared thermal control circuitry 216 to process an output of the temperature sensor 212 in a selected thermal zone 208.

The fluidic die 206 may further include a sequencer 218 to output a sequence state 220 to select one thermal zone 208 at a time for processing by the shared thermal control circuitry 216. The decoder 222 of the selected thermal zone 208 may decode the sequence state 220 output by the sequencer 218. In an example, the sequence state 220 may include a number of bits that uniquely identify each thermal zone 208 based on a state of the bits.

When the decoder 222 of the selected thermal zone 208 decodes the sequence state 220, then the selected thermal zone 208 is selected for processing by the shared thermal control circuitry 216. For example, the temperature sensor 212 of the selected thermal zone 208 may transmit thermal data from the selected thermal zone 208 to the shared thermal control circuitry 216. The shared thermal control circuitry 216 may then transmit thermal control data to the selected thermal zone 208.

The sequencer 218 may increment the sequence state 220 by a command from the shared thermal control circuitry 216 once processing of the selected thermal zone 208 is complete. In some examples, the sequencer 218 may increment the sequence state 220 in a repeating sequence.

FIG. 3 is a block diagram illustrating an example of a fluidic die 306 for thermal zone selection with a sequencer 318 and decoders 322. The fluidic die 306 may be implemented in accordance with the fluidic die 106 described in connection with FIG. 1 and the fluidic die 206 described in connection with FIG. 2.

The fluidic die 306 may include multiple thermal zones 308a-c. In this example, three thermal zones 308a-c are depicted. However, the fluidic die 306 may include at least two thermal zones 308. Each thermal zone 308 may include a temperature sensor 312, an adjustment register (adjust reg) 334 and an actuation pulse adjuster (pulse adjuster) 314.

The fluidic die 306 may also include a shared thermal control circuitry 316. The shared thermal control circuitry 316 may be coupled to the temperature sensors 312a-c and the adjustment registers 334a-c. In this example, the shared thermal control circuitry 316 may be coupled to the temperature sensors 312a-c via a temperature sensor bus on which the temperature sensors 312a-c may send their temperature sensor output 346.

The shared thermal control circuitry 316 may be coupled to the adjustment registers 334a-c via an adjust value bus over which the shared thermal control circuitry 316 may send an adjustment value signal 348 to the adjustment registers 334a-c. The adjustment value signal 348 may indicate an amount to adjust the fire pulse 352 by the actuation pulse adjuster 314.

An actuation pulse adjuster 314 may output an adjusted actuation pulse 353 (e.g., fire pulse or PCP) based on the adjustment value 348 received from the adjustment register 334. For example, when the actuation pulse adjuster 314 receives a fire pulse 352, then the actuation pulse adjuster 314 may trim or lengthen the fire pulse 352 according to the adjustment value 348 to produce the adjusted actuation pulse 353. In another example, the actuation pulse adjuster 314 may trim or lengthen the PCP according to the adjustment value 348 to produce the adjusted actuation pulse 353.

The shared thermal control circuitry 316 may also be coupled to the adjustment registers 334a-c via a register enable bus. The shared thermal control circuitry 316 may send a register enable signal 350 to the adjustment registers 334a-c via the register enable bus. The register enable signal 350 may enable an adjustment register 334 to store the adjustment value 348 provided by the shared thermal control circuitry 316. The register enable signal 350 may be “1” when active and “0” when inactive.

Each of the adjustment registers 334a-c may be coupled to an AND gate 332. One input of the AND gates 332a-c may be coupled to the register enable signal 350. Another input of the AND gates 332a-c may be coupled to a zone select signal 342. When both of the register enable signal 350 and the zone select signal 342 are “1” (e.g., logic “1”) for a given adjustment register 334, then the given adjustment register 334 may store the adjustment value 348 and pass the adjustment value 348 to its respective actuation pulse adjuster 314. It should be noted that the same logical function of the AND gates 332 may be accomplished with other logical gates than the AND gates 332 described herein.

The zone select signal 342 of a thermal zone 308 may also be coupled to the temperature sensor 312 of that thermal zone 308. The temperature sensor 312 may output its temperature measurement when the zone select signal 342 is “1”. Thus, the shared thermal control circuitry 316 may receive the temperature sensor output 346 of the selected thermal zone 308.

The fluidic die 306 may include a sequencer 318 and decoders 322a-c to select a thermal zone 308 for processing by the shared thermal control circuitry 316. In this example, the sequencer 318 may provide a sequence state 320, which may be implemented as described in connection with FIG. 1. Because there are three thermal zones 308 in this example, the sequence state 320 may be implemented as a 2-bit number having a maximum of 4 distinct states.

Each thermal zone 308 may include a decoder 322. The sequencer 318 may provide the sequence state 320 to the decoders 322a-c via a state bus (which may also be referred to as a zone selection address bus). For example, each of the decoders 322a-c may receive the same sequence state 320 over the state bus.

A decoder 322 may be configured to decode a certain sequence state value. For example, the decoder 322a of the first thermal zone 308a may decode a first sequence state value (e.g., “00”). The decoder 322b of the second thermal zone 308b may decode a second sequence state value (e.g., “01”). The decoder 322b of the third thermal zone 308c may decode a third sequence state value (e.g., “10”).

The output of the decoders 322a-c may be a zone select signal 342. For example, the output of the first decoder 322a may be the zone select signal 342a of the first thermal zone 308a. The output of the second decoder 322b may be the zone select signal 342b of the second thermal zone 308b. The output of the third decoder 322c may be the zone select signal 342c of the third thermal zone 308c.

A decoder 322 may output a “1” value (e.g., a logic “1”) upon decoding the sequence state 320. Otherwise, the decoder 322 may output a “0” value (e.g., logic “0”).

In this example, the sequence state 320 may be initialized by an initialization signal 335. Upon receiving the initialization signal 335, the sequencer 318 may reset the sequence state 320. For example, the sequencer 318 may reset the sequence state 320 to “00”.

The sequencer 318 may increment the sequence state 320 to select one thermal zone 308 at a time for processing by the shared thermal control circuitry 316. For example, upon initialization, the sequence state 320 may be “00”, which is decoded by the first decoder 322a. This causes the zone select signal 342a of the first thermal zone 308a to be “1” and the other zone select signals 342b,c are “0.” In this case, the temperature sensor 312a of the first thermal zone 308a may transmit its temperature sensor output 346 to the shared thermal control circuitry 316 for processing. Also, upon receiving the “1” on the zone select signal 342a, the adjustment register 334a of the first thermal zone 308a may store the adjustment value 348 sent by the shared thermal control circuitry 316.

The sequencer 318 may increment the sequence state 320 to select another thermal zone 308. For example, if the sequencer 318 increments the sequence state 320 to a value of “01”, then the sequence state 320 is decoded by the second decoder 322b, thus selecting the second thermal zone 308b for processing by the shared thermal control circuitry 316.

In some examples, the sequencer 318 may receive an increment amount 360. For example, the print system may send the increment amount 360 to the sequencer 318. The increment amount 360 may be a value (e.g., integer) that the sequencer 318 increments the sequence state 320 to select another thermal zone 308.

In some examples, the sequencer 318 may send a start processing command 354 to the shared thermal control circuitry 316 after incrementing the sequence state 320. Upon receiving the start processing command 354, the shared thermal control circuitry 316 may process the thermal data.

Upon completing the thermal data processing, the shared thermal control circuitry 316 may send a processing complete command 356 to the sequencer 318. This processing complete command 356 may cause the sequencer 318 to increment the sequence state 320 to select another thermal zone 308 for processing.

As described above, the sequencer 318 may increment the sequence state 320 by an amount other than one. For example, the sequencer 318 may increment the sequence state 320 by a non-sequential amount to cause the thermal zone selection to jump around.

In other examples, the sequencer 318 may issue a specific sequence state 320 to select an arbitrarily designated thermal zone 308 for processing. For example, the print system (e.g., fluid ejection system 102) may issue a designated zone processing command 338 to perform processing on the third thermal zone 308c. The designated zone processing command 338 may convey to the sequencer 318 the address of the thermal zone 308 to select for processing. The standard sequencing of the sequencer 318 is interrupted, and the designated address is output on the state bus. For example, the sequencer 318 may output a sequence state 220 corresponding to the address of the selected thermal zone 308. The sequencer 318 may issue a start processing command 354 to initiate the thermal data processing by the shared thermal control circuitry 316. Once the processing is complete, an analog to digital (A/D) processing result 358 may be read out to the print system.

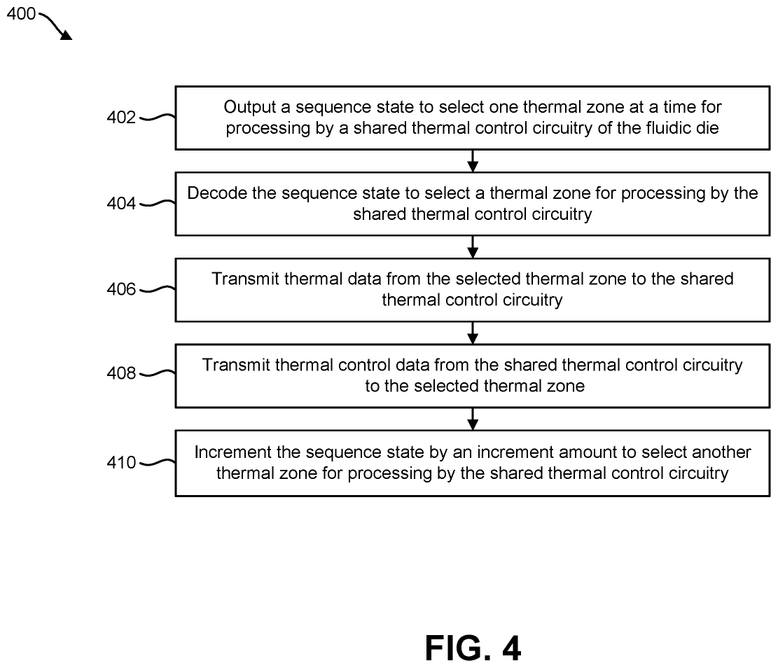

FIG. 4 is a flow diagram illustrating a method 400 for thermal zone selection with a sequencer 118 and decoders 122. The method 400 may be implemented by a fluidic die 106 that includes multiple thermal zones 108, a shared thermal control circuitry 116, a sequencer 118. Each thermal zone 108 may include a temperature sensor 112, a fluidic actuator 110 and a decoder 122.

The sequencer 118 may output 402 a sequence state 120 to select one thermal zone 120 at a time for processing by the shared thermal control circuitry 116 of the fluidic die 106. For example, the sequence state 120 may include a number of bits that uniquely identify each thermal zone 108 based on a state of the bits.

A decoder 122 may decode 404 the sequence state 120 to select a thermal zone 108 for processing by the shared thermal control circuitry 116. For example, the decoder 122 of the selected thermal zone 108 decodes 404 the sequence state 120 when a sequence state value matches a configured sequence state value of the selected thermal zone 108.

The temperature sensor 112 of the selected thermal zone 108 may transmit 406 thermal data to the shared thermal control circuitry 116. For example, the thermal zone 108 with a decoder 122 that decodes the sequence state 120 may be in an active state. The temperature sensor 112 of the selected thermal zone 108 may send its thermal data (e.g., temperature sensor output) to the shared thermal control circuitry 116.

The shared thermal control circuitry 116 may transmit 408 thermal control data to the selected thermal zone 108. For example, the shared thermal control circuitry 116 may send an actuation pulse adjustment value to a actuation pulse adjuster 114 of the selected thermal zone 108. The actuation pulse adjuster 114 may then adjust the actuation pulse based on the adjustment value. The actuation pulse may be provided to the fluidic actuator 110 of the selected thermal zone 108.

The sequencer 118 may increment the sequence state 120 ban an increment amount to select another thermal zone 108 for processing by the shared thermal control circuitry 116. For example, the increment amount may be configured during initialization. The increment amount may be an integer number N. The incremented sequence state 120 may be decoded 404 to select a subsequent thermal zone 108 for processing by the shared thermal control circuitry 116.

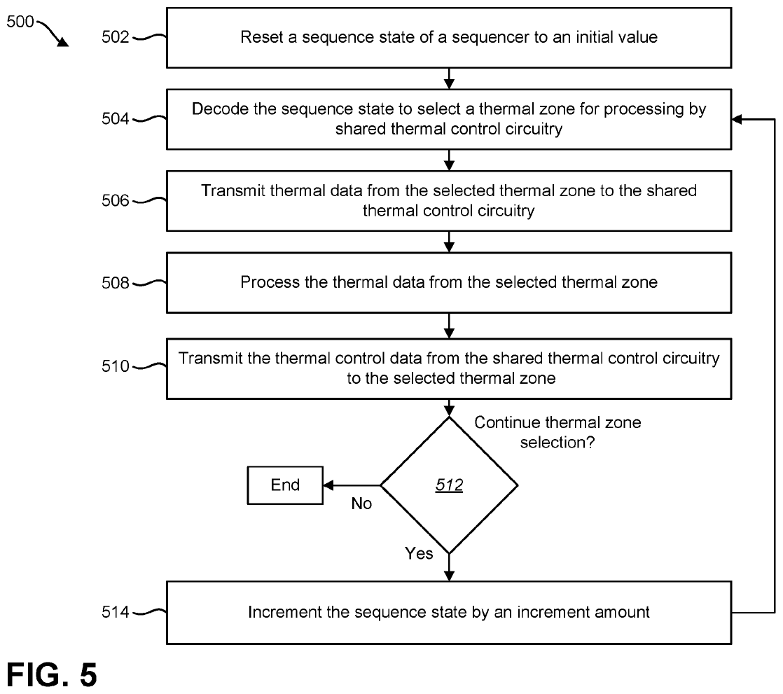

FIG. 5 is a flow diagram illustrating another method 500 for thermal zone selection with a sequencer 118 and decoders 122. The method 500 may be implemented by a fluidic die 106 that includes multiple thermal zones 108, a shared thermal control circuitry 116, a sequencer 118. Each thermal zone 108 may include a temperature sensor 112, a fluidic actuator 110 and a decoder 122.

The sequence state 120 of the sequencer 118 may be reset 502 to an initial value. For example, the sequence state 120 may be reset to “0”. The sequence state 120 indicates which thermal zone 108 is selected for processing by the shared thermal control circuitry 116. For example, a first sequence state value may indicate a first thermal zone 108 is selected, a second sequence state value may indicate a second thermal zone 108 is selected, and so forth.

The sequence state 120 may be decoded 504 to select a thermal zone 108 for processing by the shared thermal control circuitry 116. For example, each thermal zone 108 may include a decoder 122 configured to decode the sequence state 120 when the sequence state value matches the configured sequence state value of the thermal zone 108. If a decoder 122 of a given thermal zone 108 decodes the sequence state 120, then the given thermal zone 108 is selected for processing by the shared thermal control circuitry 116.

Thermal data (e.g., temperature sensor output) may be transmitted 506 from the selected thermal zone 108 to the shared thermal control circuitry 116. For example, the thermal zone 108 with a decoder 122 that decodes the sequence state 120 may be in an active state. The shared thermal control circuitry 116 may receive the temperature sensor data from the selected thermal zone 108.

Thermal data from the selected thermal zone 108 may be processed 508. For example, the shared thermal control circuitry 116 may determine an adjustment value for the actuation pulse of the selected thermal zone 108 based on the temperature sensor output.

Thermal control data may be transmitted 510 from the shared thermal control circuitry 116 to the selected thermal zone 108. For example, the shared thermal control circuitry 116 may send the actuation pulse adjustment value to the actuation pulse adjuster 114 of the selected thermal zone 108. The actuation pulse adjuster 114 may then adjust the actuation pulse based on the adjustment value.

The fluidic die 106 may determine 512 whether to continue thermal zone selection. If the thermal zone selection continues, then the sequence state 120 may be incremented 514 by an increment amount. For example, the increment amount may be configured during initialization. The increment amount may be an integer number N. The incremented sequence state 120 may be decoded 504 to select a subsequent thermal zone 108 for processing by the shared thermal control circuitry 116.

1. A fluidic die, comprising:
multiple thermal zones, wherein each thermal zone comprises a temperature sensor, a fluidic actuator and a decoder;
shared thermal control circuitry to process an output of the temperature sensor in a selected thermal zone; and
a sequencer to output a sequence state to select one thermal zone at a time for processing by the shared thermal control circuitry, wherein the decoder of the selected thermal zone decodes the sequence state.

2. The fluidic die of claim 1, wherein the sequence state is incremented by a command from the shared thermal control circuitry once processing of the selected thermal zone is complete.

3. The fluidic die of claim 1, wherein when the decoder of the selected thermal zone decodes the sequence state, then the selected thermal zone is selected for processing by the shared thermal control circuitry.

4. The fluidic die of claim 1, wherein the sequence state comprises a number of bits that uniquely identify each thermal zone based on a state of the bits.

5. The fluidic die of claim 1, wherein the selected thermal zone transmits a thermal state to the shared thermal control circuitry and receives thermal control results from the shared thermal control circuitry.

6. The fluidic die of claim 1, wherein the sequencer increments the sequence state in a repeating sequence.

7. The fluidic die of claim 1, wherein each thermal zone comprises an actuation pulse adjuster to receive an adjustment value for an adjusted actuation pulse when selected by the sequencer for processing by the shared thermal control circuitry.

8. The fluidic die of claim 1, comprising an ejection chamber fluidly coupled to a nozzle, wherein the fluidic actuator is disposed in the ejection chamber.

9. A fluid ejection device, comprising:
a fluidic die, wherein the fluidic die comprises:
multiple thermal zones, wherein each thermal zone comprises a temperature sensor, a fluidic actuator and a decoder;
shared thermal control circuitry to process an output of the temperature sensor in a selected thermal zone; and
a sequencer to output a sequence state to select one thermal zone at a time for processing by the shared thermal control circuitry, wherein the decoder of the selected thermal zone decodes the sequence state.

10. The fluid ejection device of claim 9, wherein the sequence state is incremented by a command from the shared thermal control circuitry once processing of the selected thermal zone is complete.

11. The fluid ejection device of claim 9, wherein when a decoder of the selected thermal zone decodes the sequence state, then the selected thermal zone is selected for processing by the shared thermal control circuitry.

12. The fluid ejection device of claim 9, wherein the selected thermal zone transmits a thermal state to the shared thermal control circuitry and receives thermal control results from the shared thermal control circuitry.

13. The fluid ejection device of claim 9, wherein each thermal zone comprises an actuation pulse adjuster to receive an adjustment value for an adjusted actuation pulse when selected by the sequencer for processing by the shared thermal control circuitry.

14. A method by a fluidic die, comprising:
outputting a sequence state to select one thermal zone at a time for processing by a shared thermal control circuitry of the fluidic die, wherein the fluidic die comprises multiple thermal zones, wherein each thermal zone comprises a temperature sensor, a fluidic actuator and a decoder;
decoding the sequence state to select a thermal zone for processing by the shared thermal control circuitry;
transmitting thermal data from the selected thermal zone to the shared thermal control circuitry;
transmitting thermal control data from the shared thermal control circuitry to the selected thermal zone; and
incrementing the sequence state by an increment amount to select another thermal zone for processing by the shared thermal control circuitry.

15. The method of claim 14, wherein the decoder of the selected thermal zone decodes the sequence state when a sequence state value matches a configured sequence state value of the selected thermal zone.
